(19) United States
(12) Patent Application Publication
(10) Pub. No.: US 2026/0191226 A1
(43) Pub. Date: Jul. 9, 2026

(54) DETACHABLE WATER COLLECTION BOX

(71) Applicant: Foshan WinLin Smart Technology Co., Ltd, Foshan (CN)

(72) Inventors: Jingdan XU, Foshan (CN); Huiling ZENG, Foshan (CN)

(73) Assignee: Foshan WinLin Smart Technology Co., Ltd, Foshan (CN)

(21) Appl. No.: 19/019,366

(22) Filed: Jan. 13, 2025

(30) Foreign Application Priority Data
Jan. 3, 2025 (CN) 202520015802.3

(51) Int. Cl. A23G 9/30; A23G 9/22

(52) U.S. Cl. CPC A23G 9/30; A23G 9/224

(57) ABSTRACT

The present invention relates to the technical field of collection containers, and discloses a detachable water collection box, which is disposed in a frozen beverage making machine (100). The frozen beverage making machine (100) is provided with a mixing container (20) for accommodating a finished product, the water collection box (30) is provided with a collection chamber (30a) for receiving liquid, one side of the water collection box (30) provided with the collection chamber (30a) is disposed to be attached to a lower end surface of the mixing container (20) and is detachable.

### RELATED APPLICATIONS

The present patent document claims the benefit of priority to Patent Application No. 202520015802.3, filed Jan. 3, 2025, and entitled “DETACHABLE WATER COLLECTION BOX,” the entire contents of each of which are incorporated herein by reference.

### 1. Technical Field

The present invention relates to the technical field of collection containers, and in particular to a detachable water collection box.

### 2. Background Information

A frozen beverage making machine, also known as a semi-frozen beverage making machine or crushed ice beverage making machine, can convert a beverage product from pure liquid (or a combination of liquid and some ice) into a frozen or semi-frozen product, such as a shaved ice drink, a slush drink, or another frozen or semi-frozen product, distributed, and made into a frozen or semi-frozen product and transported to a mixing container. Water droplets will condense on an outer wall of the mixing container during use due to a temperature difference. The water droplets will seep into the machine if not cleaned in time, which may cause an electronic control failure.

Therefore, in the prior art, a water collection box is disposed at a lower position of the mixing container to hold the water droplets dripping from the mixing container. The water collection box is fastened on the beverage making machine, so that it is difficult to detach and clean the water collection box subsequently. Alternatively, the mixing container and the water collection box are matched by a removal drawer at a buckle position, and the water collection box cannot be separated from the mixing container, so that it is difficult to detach the water collection box.

### BRIEF SUMMARY

The present invention provides a detachable water collection box to resolve a technical problem that a mixing container is matched with a water collection box by a removable drawer at a buckle position in the prior art, so that the water collection box cannot be separated from the mixing container, thereby causing a defect of detaching inconvenience.

Technical solutions used in the present invention to resolve the technical problem are as follows: a detachable water collection box, disposed in a frozen beverage making machine, where
the frozen beverage making machine is provided with a mixing container for accommodating a finished product,
the water collection box is provided with a collection chamber for receiving liquid, and
one side of the water collection box provided with the collection chamber is disposed to be attached to a lower end surface of the mixing container and is detachable.

In some implementations, a plurality of open grooves are formed on opposite sides of a left end and a right end of the water collection box,
and the open grooves are symmetrically arranged.

In some implementations, buckle assemblies corresponding to the open grooves are disposed on an outer side of a lower end face of the mixing container.

In some implementations, the buckle assemblies protrude outward.

In some implementations, when one end of the water collection box is axially assembled along a bottom side of the mixing container, the buckle assemblies of the mixing container are embedded in the open grooves of the water collection box.

In some implementations, the open grooves are adjacent to each other, one group of the open grooves is close to a front end of the water collection box, and
the other group of the open grooves is close to a rear end of the water collection box.

In some implementations, the open grooves are set to “L” shapes.

In some implementations, arc shapes extending downward are disposed on upper edges of adjacent sides of the open grooves, and
the arc shapes are matched with the lower end face of the mixing container.

In some implementations, a handle assembly is disposed at a front end of the water collection box, and
a hollow part is disposed between the handle assembly and the collection chamber.

In some implementations, the handle assembly, a surface facing the mixing container, and three other side walls limit the collection chamber.

In some implementations, the water collection box is made of a safety material such as PPSU, PC, PP, or PES.

In some implementations, a surface of the handle assembly facing the user is constructed to be flush with a user interface of a housing when the collection chamber is completely matched with the mixing container.

In the detachable water collection box of the present invention, the frozen beverage making machine is provided with the mixing container for accommodating a finished product and the water collection box, the water collection box is provided with the collection chamber for receiving liquid, one side of the water collection box provided with the collection chamber is disposed to be attached to a lower end surface of the mixing container and is detachable. Compared with the prior art, the water collection box and the mixing container are detachably disposed, and one side of the collection chamber is attached to the bottom side of the mixing container, so that the collection chamber can collect condensate water dripping from an outer wall of the mixing container. In addition, through buckling assembly of the water collection box and the mixing container, when remaining shaved ice or condensate in the water collection box needs to be cleaned, the mixing container is taken out and then separated from the mixing container simply and rapidly, improving the convenience of assembly and disassembly of the water collection box and the mixing container.

### BRIEF DESCRIPTION OF THE DRAWINGS

The present invention is further described with reference to accompanying drawings and embodiments. In the figures,

FIG. 1 is a three-dimensional diagram of a frozen beverage making machine according to an embodiment of the present invention;

FIG. 2 is an exploded view of the frozen beverage making machine according to an embodiment of the present invention;

FIG. 3 is an assembly diagram of a mixing container and a water collection box according to an embodiment of the present invention;

FIG. 4 is a sectional diagram of the mixing container and the water collection box according to an embodiment of the present invention;

FIG. 5 is an exploded view of the mixing container and the water collection box according to an embodiment of the present invention;

FIG. 6 is a three-dimensional diagram of the mixing container according to an embodiment of the present invention; and

FIG. 7 is a three-dimensional diagram of the water collection box according to the present invention.

### DETAILED DESCRIPTION OF THE DRAWINGS AND THE PRESENTLY PREFERRED EMBODIMENTS

To clearly understand the technical features, purposes, and effects of the present invention, specific implementations of the present invention are described in detail with reference to the accompanying drawings.

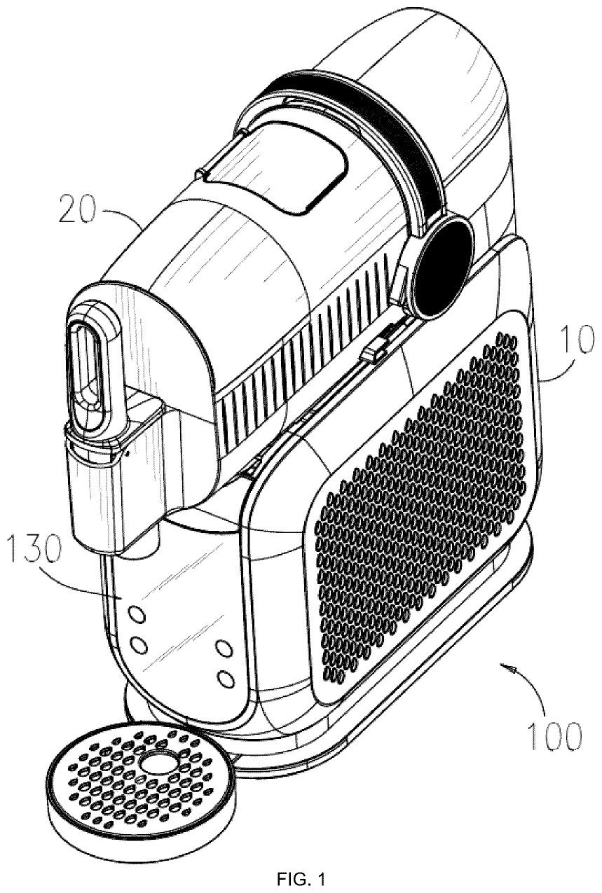

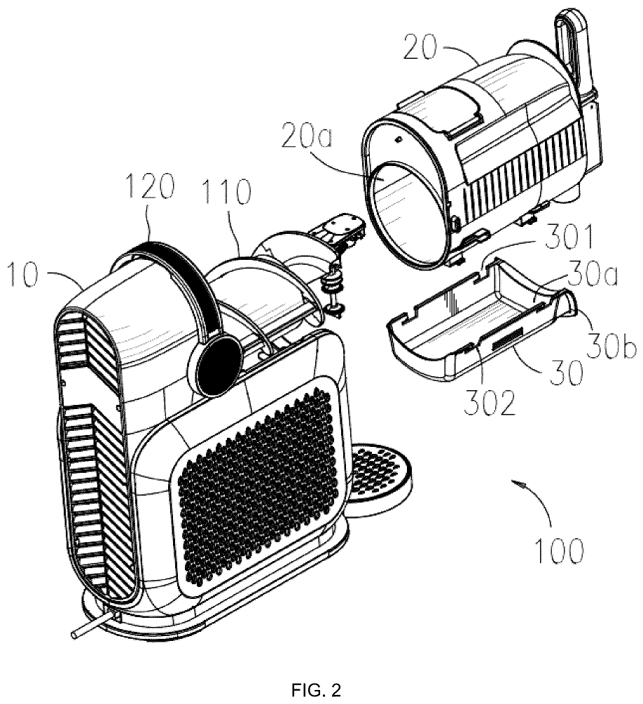

As shown in FIG. 1 and FIG. 2, in a first embodiment of a frozen beverage making machine of the present invention, the frozen beverage making machine 100 includes at least a host 10, a mixing container 20, and a water collection box 30.

The host 10 is at least provided with a compressor, a condenser, a rotary knife 110, and a lifting handle assembly 120.

The rotary knife 110 is disposed in the mixing container 20.

Two ends of the lifting handle assembly 120 are disposed on a left side and a right side of an upper end of the host 10.

The compressor compresses a refrigerant into high-temperature and high-pressure steam, which becomes liquid after cooling by the condenser. The liquid enters an evaporator through depressurization of an expansion valve and absorbs a large amount of heat to implement rapid cooling, thereby achieving the refrigeration effect.

A finished product of ice cubes or shaved ice is conveyed to the mixing container 20 by an electric motor. Fruit or beverage in the mixing container 20 is cut into small pieces by the rotary knife 110 disposed in the mixing container 20 and is evenly mixed by a stirring shaft, so that cold drinks such as shaved ice, juice, or milkshakes are produced.

The mixing container 20 is disposed in the frozen beverage making machine 100 and is a cylinder of a hollow structure 20a for accommodating ice cubes, shaved ice, or a finished product to be mixed.

The water collection box 30 is disposed on a lower end face of the mixing container 20, with one end provided with an opening, and a collection chamber 30a which can be used to collect condensate liquid is formed.

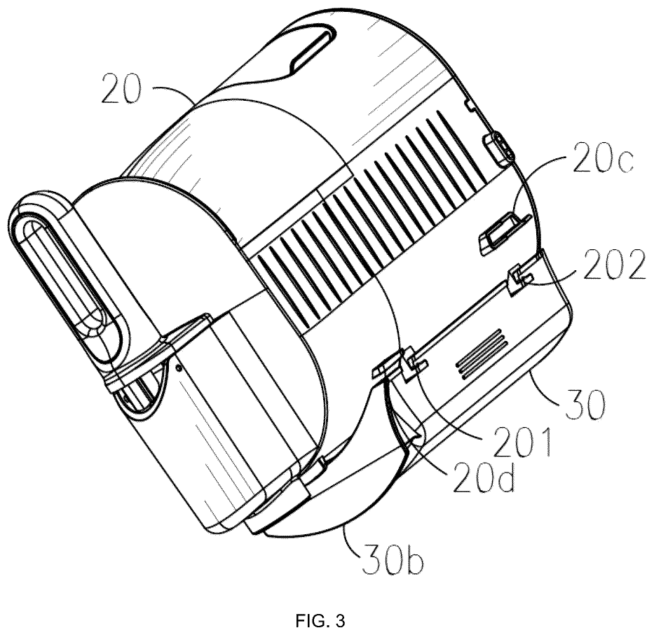

In a first embodiment of assembly of the mixing container 20 and the water collection box 30 shown in FIG. 3 to FIG. 5, the water collection box 30 is provided with the collection chamber 30a for receiving liquid, that is, the condensate liquid dripping from an outer wall of the mixing container 20.

When the frozen beverage making machine 100 is in a working state, condensate water is formed on the outer wall of the mixing container 20 due to a low internal temperature, and condensate water located at the bottom of the mixing container 20 falls into the collection chamber 30a of the water collection box 30 below, so that a liquid collection function can be achieved, and condensate water that drips can be effectively prevented from infiltrating into the host 10, thereby improving the use comfort and the use safety of an electronic control device and a circuit.

One side of the water collection box 30 provided with the collection chamber 30a is disposed to be attached to a lower end surface of the mixing container 20 and is detachable.

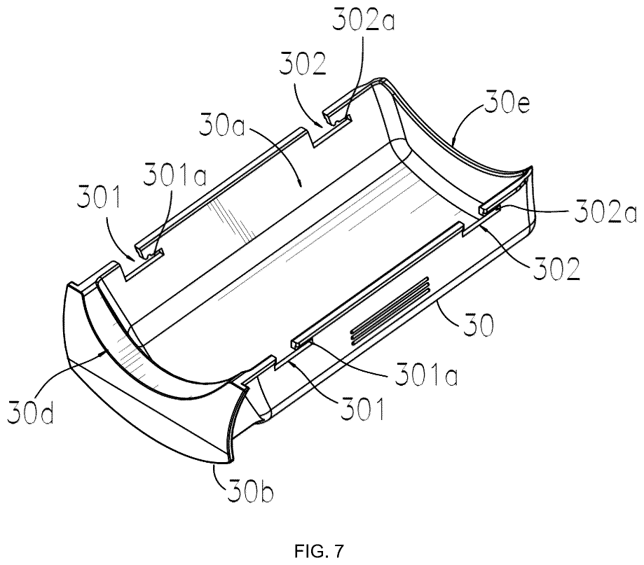

Specifically, as shown in FIG. 7, a plurality of open grooves (301, 302) are formed on opposite sides of a left end and a right end of the water collection box 30, and the open grooves (301, 302) are symmetrically arranged.

One open groove 301 on an outer edge is disposed adjacent to the other open groove 302.

A group of oppositely arranged open grooves 301 are close to a front end of the water collection box 30.

The other group of oppositely arranged open grooves 302 are close to a rear end of the water collection box 30.

The open grooves (301, 302) are set to “L” shapes.

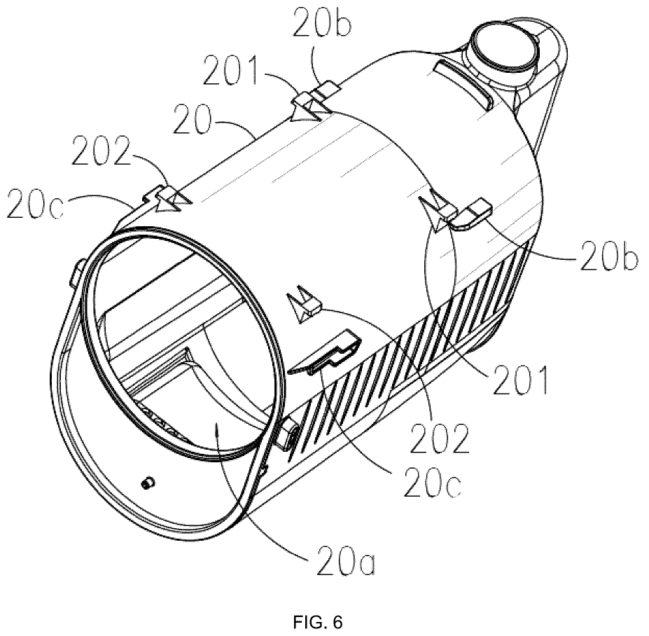

In some implementations, as shown in FIG. 6, a plurality of groups of buckle assemblies (201, 202), clamping parts 20b, and limiting parts 20c are disposed on an outer side of a lower end face of the mixing container 20.

The buckle assemblies (201, 202) are arranged corresponding to the open grooves (301, 302), and the buckle assemblies (201, 202) protrude outward.

The host 10 is provided with at least a clamping groove corresponding to the clamping part 20b and a protrusion that can be abutted against the limiting part 20c.

When the mixing container 20 is placed in a bearing position of the host 10, a first clamping part 20b is matched with the clamping groove, so that the mixing container 20 can be firmly adapted with the host 10. When the mixing container 20 is pushed into a specific position, the limiting part 20c is abutted against the protrusion, to limit an axial depth for which the mixing container 20 can be placed in the bearing position.

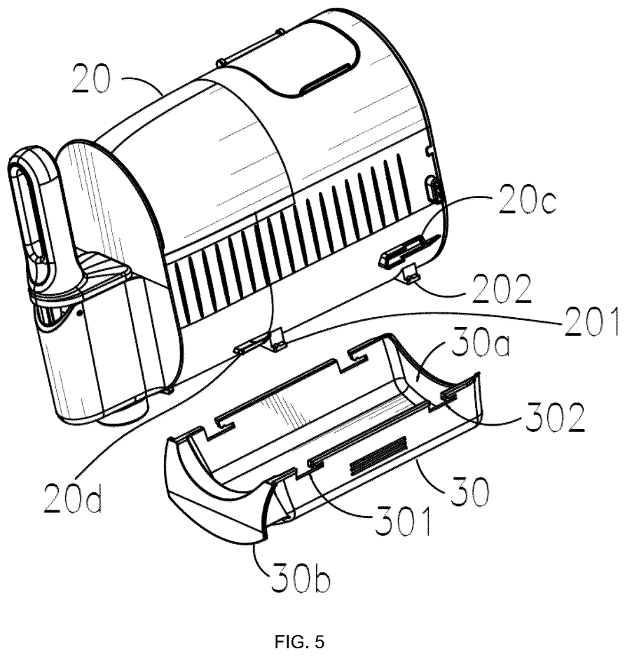

In some implementations, as shown in FIG. 5, when the water collection box 30 and the mixing container 20 are assembled, one end of the water collection box 30 can be axially assembled along a bottom side of the mixing container 20, and the buckle assemblies (201, 202) of the mixing container 20 are respectively embedded in the open grooves (301, 302) of the water collection box 30.

When the buckle assemblies (201, 202) are embedded in the open grooves (301, 302), a pulling force is applied to the water collection box 30 toward one side of a user interface of a housing 130, so that the buckle assemblies (201, 202) are firmly fastened in the open grooves (301, 302), and the water collection box 30 and the mixing container 20 are detachably assembled. Through buckling assembly, When remaining shaved ice or condensate in the water collection box 30 needs to be cleaned, the mixing container 20 is taken out, and then a thrust is applied to the water collection box 30 along a rear end direction of the mixing container 20, so that the buckle assemblies (201, 202) exit abutting chambers (301a, 302a) of the open grooves (301, 302), so that the buckle assemblies (201, 202) are separated from the abutting chambers (301a, 302a), thereby better facilitating assemble and disassemble of the water collection box 30 and the mixing container 20.

In some implementations, protruding bars that are symmetrical can also be disposed on the outer wall of the water collection box 30, the protruding bars extend outward, and sliding grooves corresponding to the protruding bars are disposed on the outer wall of the mixing container 20. When the water collection box 30 is matched with the mixing container 20, the protruding bars on the water collection box 30 are embedded in the sliding grooves of the mixing container 20, and a thrust is applied to a rear side of the mixing container 20, so that the water collection box 30 is embedded in the mixing container 20, thereby implementing detachable disposing.

The water collection box 30 and the mixing container 20 can also be detachably disposed through a screw connection. A structure that the water collection box 30 and the mixing container 20 can be removed together and are easy to detach and clean is simple and proper, and a removable condensation tray under the container is provided to reduce cleaning and increase the ease of use.

In some implementations, as shown in FIG. 7, arc shapes (30d, 30e) extending downward are disposed on upper edges of adjacent sides of the open grooves (301, 302). The arc shapes (30d, 30e) are matched with a lower end face of the mixing container 20, that is, an upper end face and the lower end face of the mixing container 20 are also disposed in an arc shape. When the water collection box 30 is matched with the mixing container 20, the arc shapes (30d, 30e) of the water collection box 30 can be closely attached to an outer wall of a bottom of the mixing container 20.

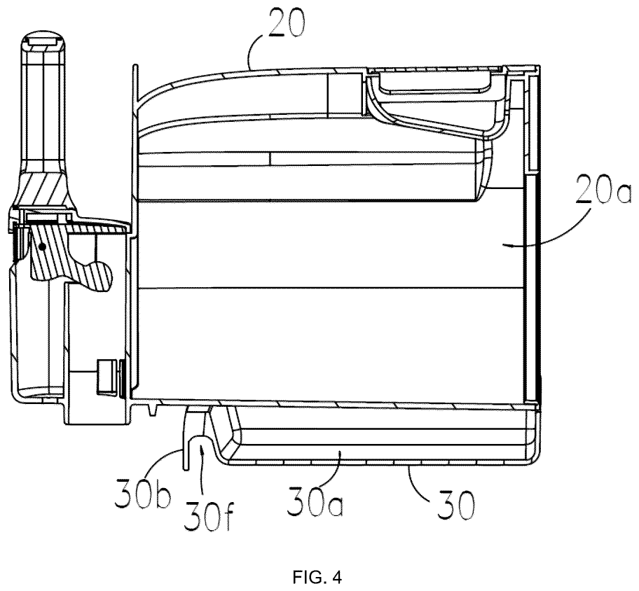

In some implementations, as shown in FIG. 3 and FIG. 4, a handle assembly 30b is disposed at a front end of the water collection box 30.

A hollow part 30f is disposed between the handle assembly 30b and the collection chamber 30a. The hollow part 30f is provided with space that can accommodate a plurality of fingers. A user can apply a pulling force or a thrust through the hollow part 30f to ensure that the water collection box 30 and the mixing container 20 are fastened or separated.

In some implementations, as shown in FIG. 7, the handle assembly 30b, a surface facing the mixing container 20, and three other side walls limit the collection chamber 30a, to reliably collect the condensate liquid dripping from the mixing container 20.

The water collection box 30 may be made of a safety material such as PPSU, PC, PP, or PES.

In some implementations, as shown in FIG. 1, a surface of the handle assembly 30b facing the user is constructed to be flush with a user interface of the housing 130 when the collection chamber 30a is completely matched with the mixing container 20.

The embodiments of the present invention are described above with reference to the accompanying drawings, but the present invention is not limited to the foregoing specific implementations, and the foregoing specific implementations are only illustrative and not restrictive. Under the enlightenment of the present invention, persons of ordinary skill in the art can make many forms without departing from the purpose of the present invention and the protection scope of the claims, all of which fall within the protection of the present invention.

1. A detachable water collection box, disposed in a frozen beverage making machine, wherein
the frozen beverage making machine is provided with a mixing container for accommodating a finished product,
the water collection box is provided with a collection chamber for receiving liquid, and
one side of the water collection box provided with the collection chamber is disposed to be attached to a lower end surface of the mixing container and is detachable.

2. The detachable water collection box according to claim 1, wherein
a plurality of open grooves are formed on opposite sides of a left end and a right end of the water collection box,
and the open grooves are symmetrically arranged.

3. The detachable water collection box according to claim 2, wherein
buckle assemblies corresponding to the open grooves are disposed on an outer side of a lower end face of the mixing container.

4. The detachable water collection box according to claim 3, wherein
the buckle assemblies protrude outward.

5. The detachable water collection box according to claim 3, wherein
when one end of the water collection box is axially assembled along a bottom side of the mixing container, the buckle assemblies of the mixing container are embedded in the open grooves of the water collection box.

6. The detachable water collection box according to claim 5, wherein
the open grooves are adjacent to each other, one group of the open grooves is close to a front end of the water collection box, and
the other group of the open grooves is close to a rear end of the water collection box.

7. The detachable water collection box according to claim 6, wherein
the open grooves are set to “L” shapes.

8. The detachable water collection box according to claim 7, wherein
arc shapes extending downward are disposed on upper edges of adjacent sides of the open grooves, and
the arc shapes are matched with the lower end face of the mixing container.

9. The detachable water collection box according to claim 3, wherein
a handle assembly is disposed at a front end of the water collection box, and
a hollow part is disposed between the handle assembly and the collection chamber.

10. The detachable water collection box according to claim 9, wherein
the handle assembly, a surface facing the mixing container, and three other side walls limit the collection chamber.

11. The detachable water collection box according to claim 10, wherein
the water collection box is made of a safety material such as PPSU, PC, PP, or PES.

12. The detachable water collection box according to claim 10, wherein
a surface of the handle assembly facing the user is constructed to be flush with a user interface of a housing when the collection chamber is completely matched with the mixing container.
